(19) United States
(12) Patent Application Publication
(10) Pub. No.: US 2008/0104934 A1
(43) Pub. Date: May 8, 2008

(54) Three-Dimentsional, Shock-Absorbing, Ergonomic, Anti-Blocking Ridings Stirrup That Can Be Adapted to the Weight of the Rider and Comprises a Foot Assisting Mechanism

(76) Inventor: Guy Morin, Valence (FR)

Correspondence Address: GREENBLUM & BERNSTEIN, P.L.C., 1950 ROLAND CLARKE PLACE, RESTON, VA, 20191, US

(21) Appl. No.: 11/814,470

(22) PCT Filed: Jan. 10, 2006
(86) PCT No.: PCT/FR06/00083

§ 371 Date: Jul. 20, 2007

(30) Foreign Application Priority Data
Jan. 24, 2005 (FR) 0500691

(51) Int. Cl. B68C 3/02

(52) U.S. Cl. 54/49

(57) ABSTRACT

The invention relates to a riding stirrup, especially provided with a foot assisting mechanism, said stirrup absorbing shocks and vibrations transmitted to the muscles, bones, tendons and joints of the rider. The inventive riding stirrup is ergonomically innovative in terms of the base thereof, and has an innovative anti-blocking system in the form of the structure thereof complemented by a lateral abutment. Said riding stirrup also comprises a supporting structure (1) ending in a square (7) carrying an arrangement (8, 5) which works in rotation on the square (7) in order to form a mini torsion bar, the amplitude of which does not exceed 20 degrees, and an arrangement (3, 6) for actuating the mini torsion bar using the foot, said arrangement enclosing the mini torsion bar. Said system accompanies the foot of the rider and replaces it in the horizontal position by means of a vertical force applied to the front or the rear of the base (3). Spheres (4) are received at defined points between the base (3) and the top of the torsion bar. When a vertical force is applied to the base (3), the spheres are compressed and rise back up, creating a flexible back-and-forth movement which is well dosed for the foot. Said spheres are at a distance from each other, and generate two functions independent of the swinging of the foot to the right and to the left. Said spheres have a hardness and different colours that can be adapted to the weight of the rider. An embodiment of the structure which is ¾ closed by a flexible abutment creates an anti-blocking safety stirrup. The invention is suitable for riders who often use the stirrups.

The present invention relates to a riding stirrup, aimed at providing the rider, at the various speeds, with stability, comfort and security. The various mechanical means used being very precisely calculated with reference to the opposing forces. The value of this innovation being the reduction of the muscular fatigue, and of the microtraumatisms generated by the impacts, the security due to an open three-quarter supporting structure making it easy to remove the foot; with an ergonomic floor closely hugging the shape of the foot.

Ninety percent of the stirrups sold are not furnished with a shock-absorbing system in certain cases the sole on which the foot rests may be furnished with a rubber sole serving more as a non-slip element than a shock absorber. At certain rapid speeds (full gallop) in the kick-backs, the feet of the rider tend to jump on said sole causing a loss of balance, or loss of the stirrup. The comfort and stability of the rider remain quite precarious, the impacts imposed by his mount are directly transmitted to the bones, to the muscles and to the ligaments.

The remaining ten percent are articulated stirrups furnished with a shock absorber, these models using either springs or rubber silent blocks; the reproach that can be made of these existing models are their excess flexibility. The opposing forces, the materials used are not sufficiently suitable; which has the effect of increasing the movements of the foot instead of assisting them. Many riders have tested and then abandoned them, the technique not corresponding to the needs.

Understanding of the device according to the invention, two mechanical means that are nested (or intimately connected) in order to arrive at finalizing a device or an integral system having five functions (or different independent movements). The supporting structure of the mechanism being manufactured in a single piece cast as a monoblock in a hard metal, said structure terminating in a metal square (or any other geometric shape for example of the cruciform type) whose top ridge and bottom ridge of this same square are oriented parallel to the axis of this structure. A metal tube of appropriate section is housed around this same square. Sections of flexible, elastic materials resistant to compression such as polyurethane, rubber, silicone or any other materials with a profile that is round, triangular, round with a shoulder or cast: of a suitable length, diameter, hardness are inserted between the four faces of this same square and the internal corners of the metal tube, in order to arrive at manufacturing a mini torsion bar. This mini torsion bar being covered with a shock-absorbing mechanism forming a body with an ergonomic floor (on which the foot of the rider rests) serves to limit, regulate, meter and above all assist the movements of the foot in its forward and rearward pressures. It limits and assists the balancing movements while regulating them, it re-establishes the balance and stability forward rearward, due to the torque ratio returning the floor or the foot to the initial or horizontal position, the flexibility being finely calculated to leave the choice free to the rider to lower or orient his heel in the position that he desires. The muscles, the bones, the tendons being less stressed due to a more naturally horizontal or flatter position of the foot.

Said mini torsion bar is covered or trapped by a metallic assembly forming the floor having an inner side approximately 10 mm greater (in its height) than the tube forming the mini torsion bar. This metal assembly furnished with the floor being freely adjusted, can slide downward or upward on the sides of the tube forming said mini torsion bar.

Two or more spheres of flexible materials are housed between the underside of the floor and the top of the tube of said torsion bar; two or more holes or reservations are provided in the floor in order to receive these spheres therein. Spheres, squares, rectangles or any other shapes of polyurethane, rubber, silicone or any other flexible material or where necessary springs being able to be used. The vertical pressure of the foot of the rider compresses and relaxes the spheres trapped between the underside of the floor and the top of the tube. It is easy to understand the comfort provided to the rider by the elasticity of the compressed spheres just under his foot. The spheres being at a distance from one another, they work independently like two shock absorbers, the floor adapts to the various lateral stands of the foot of the rider.

The floor of the stirrup works in three assisted dimensions with return to point 0 on the horizontal, vertical pressure of the foot forward or rearward, return to the initial position point 0 by means of the torsion bar. Vertical pressure, with flexibility assisted by means of the spheres compressed beneath the floor.

Vertical, lateral pressure by means of spheres at a distance (hence independent). Spheres or any other shape of materials, of hardness, of various colors may be used and adapted to the weight of each rider, for example in brackets of 15 kilos in order to adapt flexibility to the weight of each one.

A part made of flexible material comes to finalize and close the stirrup at three quarters of its opening and hold the mechanism, it is attached by means of a fastening means at the end of the square of the structure, it may be of different height, width, it may where necessary be adjusted to reduce or increase the space reserved for the boot, therefore the stirrup can be adapted to the width of the foot. It may where necessary have a shape that is much more closed and has a higher return on the shoe of the rider in order to make it a contact stirrup (in order to prevent losing the stirrup). The purpose of this half-branch or lateral abutment is to keep the foot of the rider laterally in place on the floor (or in the stirrup); it is high enough for the foot not to pass over it.

The materials used are semi-hard (in order to avoid injuring the rider and his mount in the event of a fall) polyurethane, rubber, silicone or any other material; it may where necessary be made of metal covered with flexible material. It may where necessary pivot to the horizontal on its fastening in the case of a rider fall or in the case of an impact.

The stirrup thus furnished with this part forms a three-quarter-closed stirrup.

It is easy to understand the whole value of this shape (three-quarter-closed) for the safety of the rider in the event of a fall, a shape of the structure that is progressive very open in its height in order to slide the feet, an opening of one quarter for removing the foot, a flexible part (or lateral abutment) which twists or pivots to release the foot.

The ergonomic floor is curved; it is adjusted to the shape of the forepart; its surface and its length are judiciously calculated so as not to hamper and provide maximum stability; its surface and its length and sufficiently great to set in action the mechanism of said mini torsion bar. It works like a lever arm on the mechanism in action. The non-slip element is created by a multitude of holes whose circumference is pushed out in protrusions toward the top surface of the floor, or by excrescencies of metal. A space may be provided on one of the sides in order to laterally attach there the part that is flexible or called the abutment.

The loop retaining the stirrup leather is oriented parallel to the mount of the rider, in order to position the opening of the stirrup facing the tip of the toe.

Exemplary embodiment of the invention; it will be better understood thanks to the following description and to the drawings accompanying it in a nonlimiting embodiment.

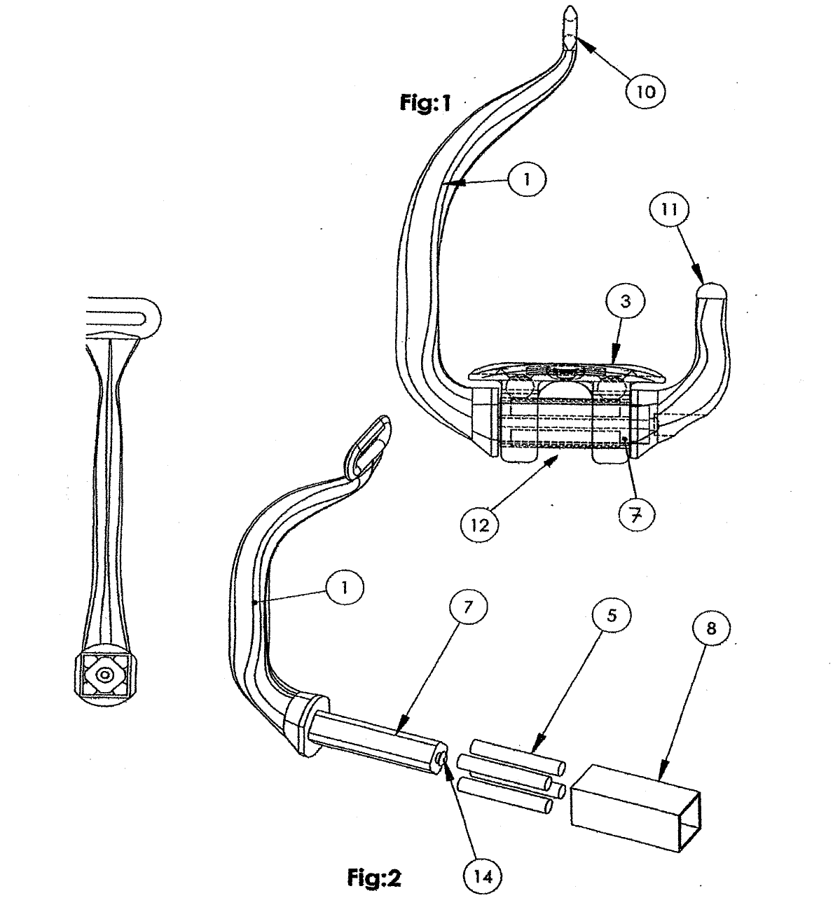

FIG. 1 represents a front view of the integrated supporting structure of the mechanism, and finalized by the foot abutment made of flexible material.

FIG. 2 represents a front view of said mini torsion bar.

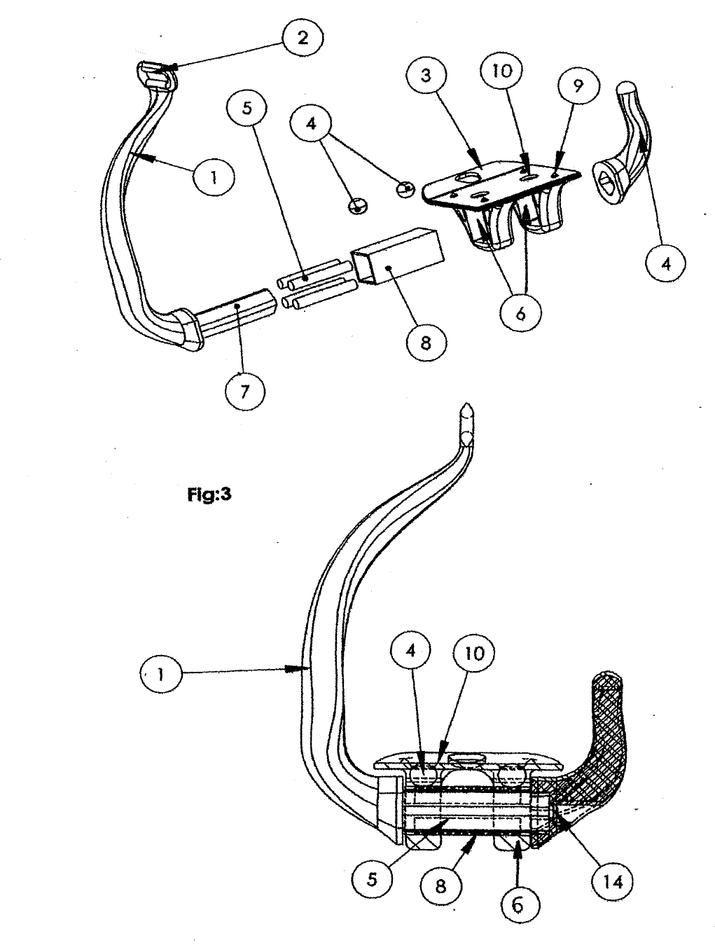

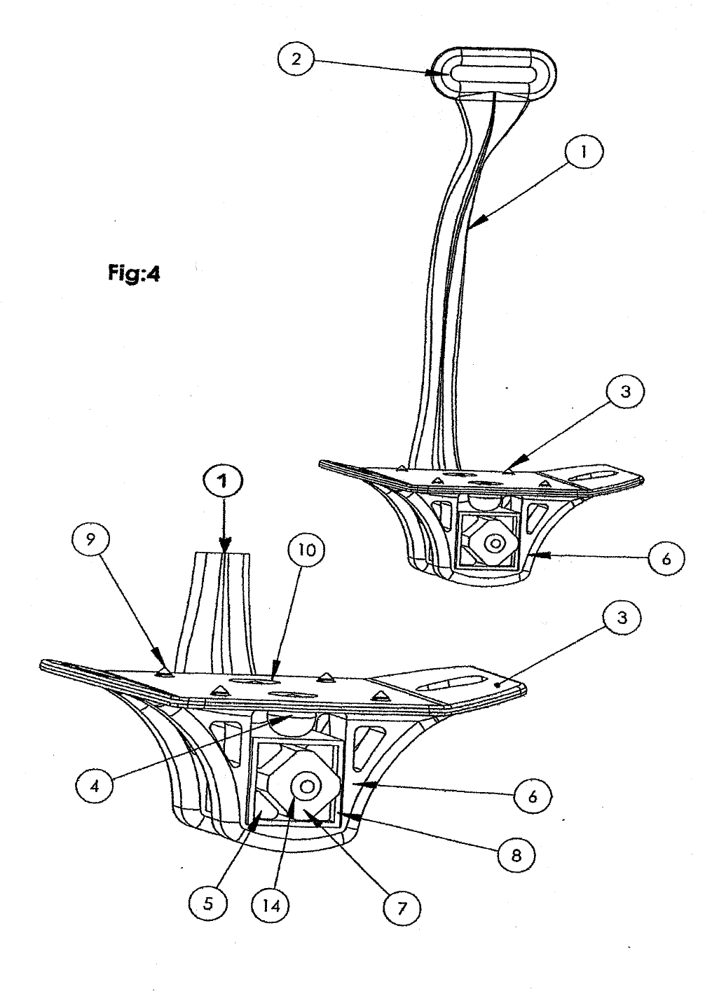

FIG. 3 represents an exploded view of both of the mechanical systems and an assembled view.

FIG. 4 represents a view of the two mechanisms assembled onto the supporting structure.

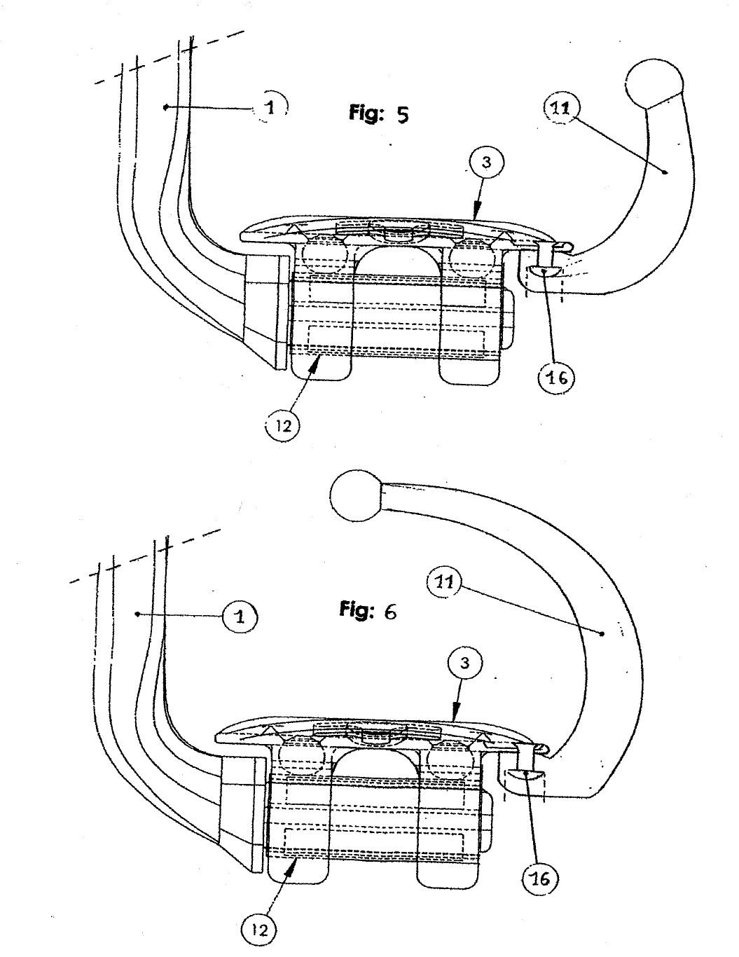

FIG. 5 represents a different type of assembly (or of positioning) of the foot abutment made of flexible material attached to the edge of the floor.

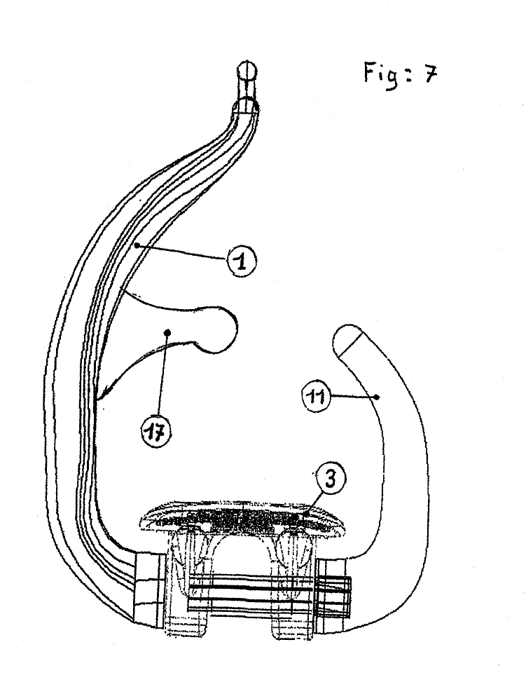

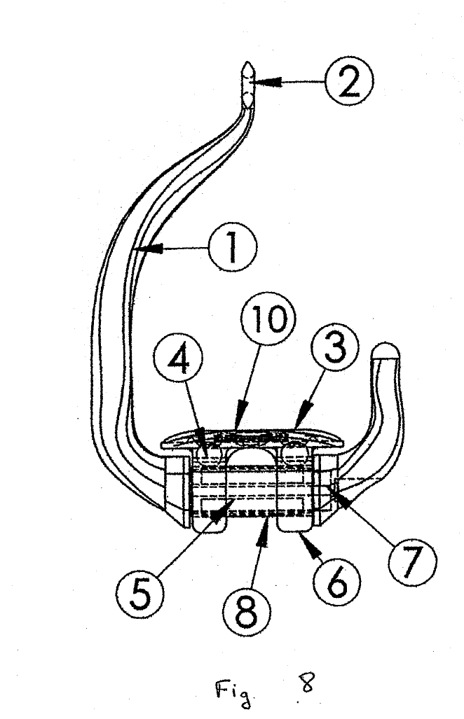

FIG. 6 represents a view of the foot abutment attached to the edge of the floor, in a different shape, with return on the shoe.

As shown in FIG. 1, the riding stirrup is formed of a supporting structure 1 on which a mechanical assembly 12 rests terminating in a foot abutment 11 made of flexible material; this mechanical assembly 12 has the ability by means of the floor 3 to be lowered from 0 to 50 degrees maximum (in relation to the opposing forces) forward or rearward of the vertical of the structure 1; this same assembly 12, by vertical pressure on the floor 3, falls and rises, always by the same pressure on the floor 3 it can fall independently on the side of the structure 1, on the abutment side 11.

Detail in the embodiment, as can be seen in FIGS. 1, 2, 3, 4.

The supporting structure 1, FIG. 2, in its shape terminates in a solid square 7; this square or any other geometric form, for example cruciform, having several functions, it serves as a bearing surface to the mechanical support 12, on which the torsion movement is created; at its end a fastening means 14 is arranged by means of a part cast from the block, this same static square 7 having at least two ridges positioned in the vertical direction of the structure 1, a section of tube 8 with an inner side greater than the four ridges of the square 7 comes to be housed around the square 7 in order to trap it. This same tube 8 will generate the torsion (or pivot) movement forward, rearward. Portions of flexible materials 5 of suitable length, diameter, of round shapes with shoulder or triangular, of appropriate hardness such as polyurethane, rubber, silicon or other materials, will penetrate by force between the four faces of the square 7 and the internal corners of the tube 8 in order to materialize the torsion movements of the tube 8.

The means used to generate the torsion movements of this assembly 7, 5 and 8 are the floor 3 and its profiled supports 6 together.

A metal assembly, FIG. 3, formed of two U-shaped parts 6 of adjusted dimension, and of an internal height that is approximately 10 mm greater than the tube 8, connected to the floor 3 and forming a single cast part, this same assembly covers or traps the tube 8.

This same assembly 3 and 6 having 3 different mechanical functions.

This mechanical assembly 3 and 6 adjusted in contact with the two faces of the tube 8 can navigate upward, it is guided and held laterally on one of the sides by the abutment 4 furnished with a shim, on the other side by the shoulder cast in the structure 1.

Spheres 4, two or more, squares, rectangles with a hardness, size (volume) that is appropriate in flexible material such as polyurethane or other materials, or metal springs, will be housed between the floor 3 and the supporting tube 8, FIG. 4; spaces or reservations 10 are machined or arranged in the floor 3 in order to keep the spheres 4 in place at a determined distance.

This mechanical assembly thus assembled as can be seen in FIG. 4 generates, by means of the foot of the rider resting on the floor 3, five different functions while assisting his foot flexibly.

First function: vertical pressure force on the front of the assembly 3 and 6, the assembly 3 and 6 tilts and takes with it the tube 8 which squeezes the flexible materials 5 on the fixed square 7. The pressure force releasing the floor 3 returns to the horizontal (or point 0).

Second function: the vertical pressure force on the rear of the assembly 3 and 6 causing the same effects of return to the horizontal (or point 0). The elastic forces being calculated so that the floor 3 does not adopt an angle greater than 20 degrees.

Third function: the vertical pressure force on the floor assembly 3 compresses and relaxes the spheres 4 resting on the tube 8 creating a back-and-forth movement. It is easy to understand the whole value of these compressed spheres which swell and subside under the pressure releasing a progressive energy.

Fourth and fifth functions: these same spheres 4 being at a distance from one another, FIG. 3, in their housing 10, on compression they create two independent functions, the stand of the foot laterally may therefore be corrected by squeezing one or other of these two spheres.

The abutment 11, FIG. 1, of the foot made of flexible material serving to hold the mechanism in place and retain the foot of the rider laterally in the stirrup comes to be attached at the end of the square 7, it may if necessary pivot on its fastening 14, FIG. 2. It may also be attached to the side of the floor 3, FIG. 5; it may also be adjusted and slide in its fastening 16 in order to make it a stirrup that can be adjusted to the width of the foot.

The abutment 11, FIG. 6, may also have a shape returning on the shoe in order to hold the foot on the floor 3 and therefore make it a contact stirrup in its height while retaining maximum security.

The foot abutment 17, FIG. 7, made of flexible material is attached to the branch 1 at a certain height, in order to keep the foot on the floor 3 it can

An ergonomic floor 3, FIG. 4, of a shape curved upward on its front and rear portion at an angle of approximately 165 degrees closely hugs the shape of the sole, its surface, its length and its shape being sufficient to give a maximum of stability to the foot; it is furnished with non-slip element 9 created directly in the material, or fitted.

The mechanism may well be used on a conventional closed stirrup shape.

In equestrianism, the stirrup, FIG. 1, of the present invention may be used at several levels; it is suitable for the various equestrian disciplines through its design and its benefits; it is aimed mainly at riders spending long hours on their mounts, endurance, trekking, instructor, outdoor school and show jumping. It provides a maximum of comfort and safety to the rider.

Naturally the invention is not limited to the sole embodiment described, modifications remaining possible from the point of view of the make-up of the various elements, or by the substitution of a technical equivalent without, for all that, departing from the field of protection of the present cited invention.

1. A riding stirrup formed of a supporting structure 1, terminated by a solid square 7, a mechanism 8, 5 mounted pivotingly at an angle from 0 to 50 degrees forward and rearward is inserted in the bottom portion of the structure 1 and around the square 7, a second mechanical assembly of which one or two U-shaped profiles 6, a floor 3, spheres 4 having the ability to move vertically relative to the axis of the supporting structure 1; compresses and relaxes the spheres 4 by the pressure on the floor 3 this mechanism comes to be housed and trap the first mechanism 7, 8, 5. A foot abutment is also mounted at the end of the structure 1 and at the end of the square 7, (it comes to retain the mechanism and closed the stirrup ¾); it can pivot on its attachment. An ergonomic, curved floor 3, adapted to the sole furnished with a non-slip element 9, mounted or fitted into its structure, a stirrup leather loop oriented parallel to the mount.

2. The stirrup as claimed in claim 1, characterized in that the supporting structure 1 terminates in its bottom portion in a square 7 (or any other geometric shape, example cruciform) that is solid and fixedly attached to the latter, two opposite ridges of this square 7 are oriented in the axis of the structure 1, a fastening means (nonlimiting) is arranged at the end of this same square 7 via a threaded hole a stainless steel washer, a screw, or a protruding portion.

3. The stirrup as claimed in claim 1, characterized in that a metal tube 8 of suitable length and with an inner side greater than the four ridges of the solid square 7 comes to be housed around the square 7.

4. The stirrup as claimed in claim 3, characterized in that four single sections or in several elements of flexible material come to penetrate by force between the four faces of the solid square 7 and the four internal corners of the tube 8, this flexible material 5 preferably being polyurethane, rubber, or molded or cast material.

5. The stirrup as claimed in claim 3, characterized in that this mechanical assembly 7, 8 and 5 has the ability to pivot forward and backward at an angle from 0 to 50 degrees relative to the supporting structure 1, with return to the initial position; it is actuated by a novel floor assembly 3, U-shaped profile 6 connected or forming a single part.

6. The stirrup as claimed in claim 1, characterized in that one or two U-shaped profiles 6 connected and forming an integral part of the floor 3, comes to be positioned and slide on the front and rear face of the tube 8, the internal height of these sections 6 being an average dimension of 10 mm (approximately) greater than the height of the tube 8, in order to arrange a space therein, this same assembly 6 and floor 3 being foundry cast in a single piece or reconstituted.

7. The stirrup as claimed in claim 6, characterized in that the two or more spheres 4, made of flexible and/or resilient material, preferably polyurethane, rubber, of different density, hardness and color, come to be housed between the floor 3 and the tube 8, serving as a support for the spheres 4 in the spaces 10 provided or machined. On compression on relaxation these spheres 4 come to materialize the downward and upward movements of the floor 3.

8. The stirrup as claimed in claim 7, characterized in that the spheres 4 are placed at a distance from one another on each side of the floor 3 or of the tube 8, housed in the spaces 10 made in the floor 3; they generate two independent functions on vertical pressure (on each side) on the floor 3.

9. The stirrup as claimed in claim 7, characterized in that spheres, squares or any other shape, or metal springs, through their density, their hardness, are adapted to the different weight of each rider, in successively determined weight brackets, a different color of this material corresponding to each of these brackets.

10. The stirrup as claimed in claim 1, characterized in that a lateral foot abutment 11 serving to hold the mechanism 12 in place, made of flexible or semi-hard material, preferably polyurethane, rubber or metal covered with flexible material, comes to be attached at the end of the square 7, by the attachment means 14 and having the ability to pivot on this same attachment means 14, in order to make a ¾ closed stirrup thereof.

11. The stirrup as claimed in claim 1, characterized in that the supporting structure is approximately three-quarters closed; an opening in the top portion of the structure is made in order to release the foot.

12. The stirrup as claimed in claim 1, characterized in that a variant of positioning of the lateral foot abutment 11 FIG. 5 in flexible or semi-hard material, preferably polyurethane, rubber or metal covered with flexible material comes to be attached to the floor 3 and beneath the floor 3 under its outer side, facing the structure 1 by an attachment means 16 having the ability to slide in order to reduce or increase the space reserved for the foot.

13. The stirrup as claimed in claim 12, characterized in that the lateral foot abutment 11 FIG. 6 in flexible or semi-hard material, preferably polyurethane, rubber or metal covered with flexible material comes to be attached to the floor 3 and under its external side facing the structure 1 by an attachment means 16 having the ability to slide in the attachment means 16 in order to reduce or increase the space reserved for the foot, of a shape rising above the foot, in order to make thereof a stirrup of contact with the foot and to hold it.

14. The stirrup as claimed in claim 1, characterized in that a floor 3 that is ergonomic and bent in its front rear portion toward its upper face at an angle of 165 degrees approximately, of a length, of a width and of a surface area sufficiently large to actuate the mechanism 7, 8 and 5 is furnished with a non-slip element 9 created from its block, or pierced with a multitude of holes whose circumference is pushed upward.

15. The stirrup as claimed in claim 1, characterized in that the mechanism can of course be used on a conventional closed stirrup shape.

16. The stirrup as claimed in claim 13, characterized in that a second foot abutment 17 FIG. 7 made of flexible or semi-hard material, or of metal covered with flexible material, comes to be attached to the branch 1 on its inner side, at a certain height, being adjustable upward and downward in order to keep the foot on the floor.
